(19) United States
(12) Patent Application Publication
(10) Pub. No.: US 2025/0024882 A1
(43) Pub. Date: Jan. 23, 2025

(54) DUAL MAGNETIC VAPE PEN

(71) Applicant: NUMAIR FAKIR, BREA, CA (US)

(72) Inventor: NUMAIR FAKIR, BREA, CA (US)

(21) Appl. No.: 18/355,657

(22) Filed: Jul. 20, 2023

Related U.S. Application Data
(63) Continuation-in-part of application No. 17/884,812, filed on Aug. 10, 2022.

(51) Int. Cl. A24F 40/40; A24F 7/00; A24F 40/10; A24F 40/30; A24F 40/50

(52) U.S. Cl. CPC A24F 40/40; A24F 7/00; A24F 40/10; A24F 40/30; A24F 40/50; H01F 7/02

(57) ABSTRACT

A vaporizer apparatus has a first vaporizer that has a first mouthpiece, a first oil tank, a first battery and a first electronic controller. A second vaporizer includes a second mouthpiece, a second oil tank, a second battery, and a second electronic controller. A first vaporizer back is formed on the first vaporizer. The first vaporizer back has a flat face. The second vaporizer back is formed on the second vaporizer. The second vaporizer back has a flat face. A magnetic attachment connects the first vaporizer to the second vaporizer. The magnetic attachment biases the first mouthpiece to the second mouthpiece allowing user inhalation from both the first mouthpiece and the second mouthpiece simultaneously when the vaporizer apparatus is in the connected mode. The first vaporizer and the second vaporizer are separated from each other in a separate mode.

### FIELD OF THE INVENTION

The present invention is in the field of electronic vaporizers.

### DISCUSSION OF RELATED ART

Popular smoking articles, such as cigarettes, have a substantially cylindrical rod shaped structure and include a charge, roll, or column of smokable material, such as shredded tobacco (e.g., in cut filler form), surrounded by a paper wrapper, thereby forming a so-called “smokable rod” or “tobacco rod.” Normally, a cigarette has a cylindrical filter element aligned in an end-to-end relationship with the tobacco rod. Preferably, a filter element comprises plasticized cellulose acetate tow circumscribed by a paper material known as “plug wrap.” Certain filter elements can incorporate polyhydric alcohols. See, for example, UK Pat. Spec. 755,475. Certain cigarettes incorporate a filter element having multiple segments, and one of those segments can comprise activated charcoal particles. See, for example, U.S. Pat. No. 5,360,023 to Blakley et al. and U.S. Pat. No. 6,537,186 to Veluz. Preferably, the filter element is attached to one end of the tobacco rod using a circumscribing wrapping material known as “tipping paper.” It also has become desirable to perforate the tipping material and plug wrap, in order to provide dilution of drawn mainstream smoke with ambient air. Descriptions of cigarettes and the various components thereof are set forth in Tobacco Production, Chemistry and Technology, Davis et al. (Eds.) (1999). Traditionally, a cigarette of the most popular type is employed by a smoker by lighting one end thereof and burning the tobacco rod. The smoker then receives mainstream smoke produced by the burning tobacco into his/her mouth by drawing on the opposite end (e.g., the filter end) of the cigarette.

Various tobacco substitute materials have been proposed, and substantial listings of various types of those materials can be found in U.S. Pat. No. 4,079,742 to Rainer et al. and U.S. Pat. No. 4,771,795 to White et al. Certain cigarette-type products that employ non-tobacco materials (e.g., dried vegetable leaves, such as lettuce leaves) as filler that is burned to produce smoke that resembles tobacco smoke have been marketed under the trade names “Cubebs,” “Triumph,” “Jazz,” and “Bravo.” See, for example, the types of materials described in U.S. Pat. No. 4,700,727 to Torigian. Furthermore, tobacco substitute materials having the trade names “Cytrel” and “NSM” were introduced in Europe during the 1970s. Representative types of proposed synthetic tobacco substitute materials, smokable materials incorporating tobacco and other components, and cigarettes incorporating those materials, are described in British Pat. No. 1,431,045; and U.S. Pat. No. 3,738,374 to Bennett; U.S. Pat. No. 3,844,294 to Webster; U.S. Pat. No. 3,878,850 to Gibson et al.; U.S. Pat. No. 3,931,824 to Miano et al.; U.S. Pat. No. 3,943,941 to Boyd et al.; U.S. Pat. No. 4,044,777 to Boyd et al.; U.S. Pat. No. 4,233,993 to Miano et al.; U.S. Pat. No. 4,286,604 to Ehretsmann et al.; U.S. Pat. No. 4,326,544 to Hardwick et al.; U.S. Pat. No. 4,920,990 to Lawrence et al.; U.S. Pat. No. 5,046,514 to Bolt; U.S. Pat. No. 5,074,321 to Gentry et al.; U.S. Pat. No. 5,092,353 to Montoya et al.; U.S. Pat. No. 5,778,899 to Saito et al.; U.S. Pat. No. 6,397,852 to McAdam; and U.S. Pat. No. 6,408,856 to McAdam. Furthermore, various types of highly processed smokable materials incorporating tobacco and other ingredients are set forth in U.S. Pat. No. 4,823,817 to Luke; U.S. Pat. No. 4,874,000 to Tamol et al.; U.S. Pat. No. 4,977,908 to Luke; U.S. Pat. No. 5,072,744 to Luke et al.; U.S. Pat. No. 5,829,453 to White et al.; and U.S. Pat. No. 6,182,670 to White et al.

Numerous references have proposed various smoking articles of a type that generate flavored vapor, visible aerosol, or a mixture of flavored vapor and visible aerosol. Some of those proposed types of smoking articles include tubular sections or longitudinally extending air passageways. See, for example, those types of smoking articles described in U.S. Pat. No. 3,258,015 to Ellis et al.; U.S. Pat. No. 3,356,094 to Ellis et al.; U.S. Pat. No. 3,516,417 to Moses; U.S. Pat. No. 4,347,855 to Lanzellotti et al.; U.S. Pat. No. 4,340,072 to Bolt et al.; U.S. Pat. No. 4,391,285 to Burnett et al.; U.S. Pat. No. 4,917,121 to Riehl et al.; U.S. Pat. No. 4,924,886 to Litzinger; and U.S. Pat. No. 5,060,676 to Hearn et al. Many of those types of smoking articles have employed a combustible fuel source that is burned to provide an aerosol and/or to heat an aerosol-forming material. See, for example, the background art cited in U.S. Pat. No. 4,714,082 to Banerjee et al. and U.S. Pat. No. 4,771,795 to White et al.; which are incorporated herein by reference. See, also, for example, those types of smoking articles described in U.S. Pat. No. 4,756,318 to Clearman et al.; U.S. Pat. No. 4,714,082 to Banerjee et al.; U.S. Pat. No. 4,771,795 to White et al.; U.S. Pat. No. 4.793,365 to Sensabaugh et al.; U.S. Pat. No. 4,917,128 to Clearman et al.; U.S. Pat. No. 4,961,438 to Korte; U.S. Pat. No. 4.966,171 to Serrano et al.; U.S. Pat. No. 4,969,476 to Bale et al.; U.S. Pat. No. 4,991,606 to Serrano et al.; U.S. Pat. No. 5,020,548 to Farrier et al.; U.S. Pat. No. 5,033,483 to Clearman et al.; U.S. Pat. No. 5,040,551 to Schlatter et al.; U.S. Pat. No. 5,050,621 to Creighton et al.; U.S. Pat. No. 5,065,776 to Lawson; U.S. Pat. No. 5,076,296 to Nystrom et al.; U.S. Pat. No. 5,076,297 to Farrier et al.; U.S. Pat. No. 5,099,861 to Clearman et al.; U.S. Pat. No. 5,105,835 to Drewett et al.; U.S. Pat. No. 5,105,837 to Barnes et al.; U.S. Pat. No. 5,115,820 to Hauser et al.; U.S. Pat. No. 5,148,821 to Best et al.; U.S. Pat. No. 5,159,940 to Hayward et al.; U.S. Pat. No. 5,178,167 to Riggs et al.; U.S. Pat. No. 5,183,062 to Clearman et al.; U.S. Pat. No. 5,211,684 to Shannon et al.; U.S. Pat. No. 5,240,014 to Deevi et al.; U.S. Pat. No. 5,240,016 to Nichols et al.; U.S. Pat. No. 5,345,955 to Clearman et al.; U.S. Pat. No. 5,551,451 to Riggs et al.; U.S. Pat. No. 5,595,577 to Bensalem et al.; U.S. Pat. No. 5,819,751 to Barnes et al.; U.S. Pat. No. 6,089,857 to Matsuura et al.; U.S. Pat. No. 6,095,152 to Beven et al; U.S. Pat. No. 6,578,584 Beven; and U.S. Pat. No. 6,730,832 to Dominguez; which are incorporated herein by reference. Furthermore, certain types of cigarettes that employ carbonaceous fuel elements have been commercially marketed under the brand names “Premier” and “Eclipse” by R. J. Reynolds Tobacco Company. Sec, for example, those types of cigarettes described in Chemical and Biological Studies on New Cigarette Prototypes that Heat Instead of Burn Tobacco, R. J. Reynolds Tobacco Company Monograph (1988) and Inhalation Toxicology, 12:5, p. 1-58 (2000).

Certain proposed cigarette-shaped tobacco products purportedly employ tobacco in a form that is not intended to be burned. See, for example, U.S. Pat. No. 4,836,225 to Sudoh; U.S. Pat. No. 4,972,855 to Kuriyama et al.; and U.S. Pat. No. 5,293,883 to Edwards; which are incorporated herein by reference. Yet other types of smoking articles, such as those types of smoking articles that generate flavored vapors by subjecting tobacco or processed tobaccos to heat produced from chemical or electrical heat sources, are described in U.S. Pat. No. 4,848,374 to Chard et al.; U.S. Pat. No. 4,947,874 to Brooks et al.; U.S. Pat. No. 5,060,671 to Counts et al.; U.S. Pat. No. 5,146,934 to Deevi et al.; U.S. Pat. No. 5,224,498 to Deevi; U.S. Pat. No. 5,285,798 to Banerjee et al.; U.S. Pat. No. 5,357,984 to Farrier et al.; U.S. Pat. No. 5,593,792 to Farrier et al.; U.S. Pat. No. 5,369,723 to Counts; U.S. Pat. No. 5,692,525 to Counts et al.; U.S. Pat. No. 5,865,185 to Collins et al.; U.S. Pat. No. 5,878,752 to Adams et al.; U.S. Pat. No. 5,880,439 to Deevi et al.; U.S. Pat. No. 5,915,387 to Baggett et al.; U.S. Pat. No. 5,934,289 to Watkins et al.; U.S. Pat. No. 6,033,623 to Deevi et al.; U.S. Pat. No. 6,053,176 to Adams et al.; U.S. Pat. No. 6,164,287 to White; U.S. Pat. No. 6,289,898 to Fournier et al.; U.S. Pat. No. 6,615,840 to Fournier et al.; and U.S. Patent Appl. Pub. Nos. 2003/0131859 to Li et al.; 2005/0016549 to Banerjee et al.; and 2006/0185687 to Hearn et al.; each of which is incorporated herein by reference. One type of smoking article that has employed electrical energy to produce heat has been commercially marketed by Philip Morris Inc. under the brand name “Accord.”

Certain attempts have been made to deliver vapors, sprays or aerosols, such as those possessing or incorporating flavors and/or nicotine. See, for example, the types of devices set forth in U.S. Pat. No. 4,190,046 to Virag; U.S. Pat. No. 4,284,089 to Ray; U.S. Pat. No. 4,635,651 to Jacobs; U.S. Pat. No. 4,735,217 to Gerth et al.; U.S. Pat. No. 4,800,903 to Ray et al.; U.S. Pat. No. 5,388,574 to Ingebrethsen et al.; U.S. Pat. No. 5,799,663 to Gross et al.; U.S. Pat. No. 6,532,965 to Abhulimen et al.; and U.S. Pat. No. 6,598,607 to Adiga et al; and EP 1,618,803 to Hon; which are incorporated herein by reference. See also, U.S. Pat. No. 7,117,867 to Cox et al. and the devices set forth on the website, www.e-cig.com, which are incorporated herein by reference.

### SUMMARY OF THE INVENTION

An object of the present invention is to provide a first vaping pen that has a magnetic back for easy attachment to a second vaping pen. The current invention proposes a novel form of a vape pen which is rectangle-shaped and has a flat mouth. The assembly can be attached to another pen through its magnetic back, thus allowing the user to enjoy multiple flavors conveniently.

A vaporizer apparatus has a first vaporizer that has a first mouthpiece, a first oil tank, a first battery and a first electronic controller. A second vaporizer includes a second mouthpiece, a second oil tank, a second battery, and a second electronic controller. A first vaporizer back is formed on the first vaporizer. The first vaporizer back has a flat face. The second vaporizer back is formed on the second vaporizer. The second vaporizer back has a flat face. A magnetic attachment connects the first vaporizer to the second vaporizer. The magnetic attachment biases the first mouthpiece to the second mouthpiece allowing user inhalation from both the first mouthpiece and the second mouthpiece simultaneously when the vaporizer apparatus is in the connected mode. The first vaporizer and the second vaporizer are separated from each other in a separate mode.

The magnetic attachment further has a first upper attachment, a second upper attachment, the first lower attachment, and a second lower attachment. These attachments are magnetic and metal such as steel pill shaped inserts that are formed on both the first vaporizer back and the second vaporizer back. The first mouthpiece and the second mouthpiece are adjacent in the connected mode. The magnetic attachment further includes an electrical connection between the first vaporizer and the second vaporizer. The electrical connection connects the first electronic controller to the second electronic controller. The first electronic controller and the second electronic controller preferably synchronize vapor production. The first mouthpiece has a first mouthpiece taper, and the second mouthpiece has a second mouthpiece taper. The first mouthpiece taper has a flat first mouthpiece taper back. The second mouthpiece taper has a flat second mouthpiece taper back. The first mouthpiece taper back conforms to second mouthpiece taper back to provide a combined mouthpiece taper.

### BRIEF DESCRIPTION OF THE DRAWINGS

FIG. 1 is a diagram of the present invention showing the separated mode.

FIG. 2 is a diagram of the present invention showing the combined mode.

FIG. 3 is a diagram of the present invention showing the combined mode.

FIG. 4 is a front perspective view of the present invention.

FIG. 5 is a diagram of the inside body of the present invention.

FIG. 6 is a top view.

FIG. 7 is a right side view.

FIG. 8 is a front view.

FIG. 9 is a left side view.

FIG. 10 is a bottom view.

FIG. 11 is a back view.

The following call out list of elements can be a useful guide in referencing the element numbers of the drawings.
11 first vaporizer
12 second vaporizer
13 first vaporizer back
14 second vaporizer back
15 first upper attachment
16 second upper attachment
17 first lower attachment
18 second lower attachment
20 separated mode
88 connected mode
21 first charter port
22 second charger port
23 first air intake port
24 USB port
25 first USB magnet
26 second USB magnet
27 indicator
31 outer housing
32 mouthpiece
33 oil tank
34 battery
35 electronic controller
36 electrical connectors
41 first mouthpiece taper
42 second mouthpiece taper
43 first mouthpiece taper back
44 second mouthpiece taper back
45 combined mouthpiece taper
89 first vaporizer back
87 second vaporizer back

### DETAILED DESCRIPTION

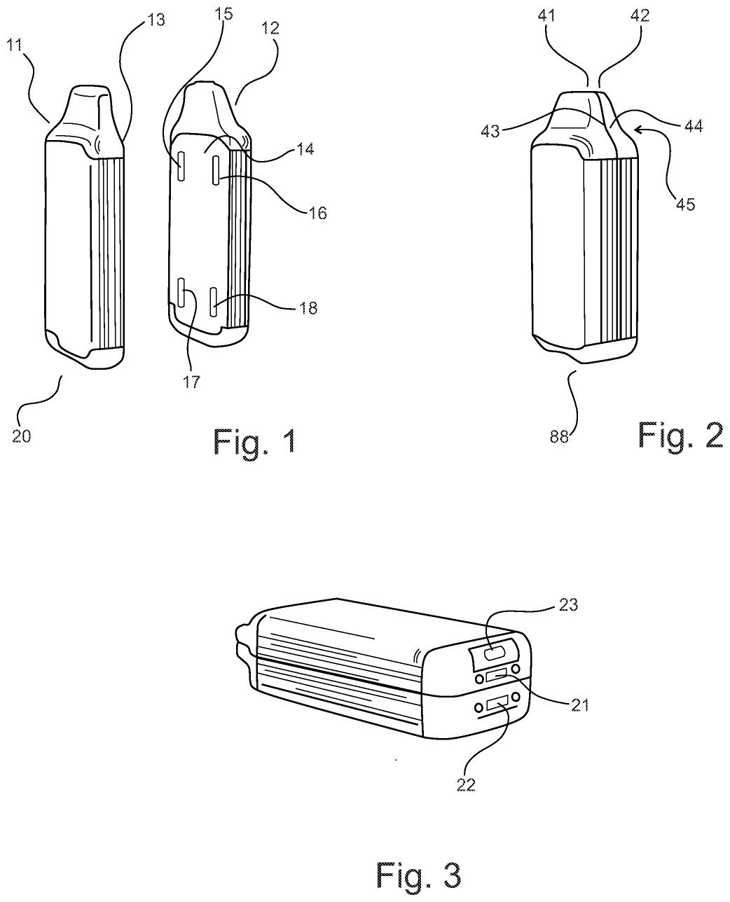

As seen in FIG. 1, the first vaporizer 11 and the second vaporizer 12 can be separated with a gap between a separated mode 20. The first vaporizer 11 has a first vaporizer back 13. The second vaporizer 12 has a second vaporizer back 14. The first vaporizer back 13 and the second vaporizer back 14 connect together at magnetic attachments. The magnetic attachments include a first upper attachment 15, a second upper attachment 16, a first lower attachment 17, and a second lower attachment 18. The first vaporizer 11 has four attachments, and the second vaporizer 12 has four attachments in a symmetrical configuration that are configured to connect with each other. The four attachments align to each other providing a magnetic latch. The four attachments can also provide an electrical connection to synchronize the electrical output and synchronize the electronic controllers.

As seen in FIG. 2, the connected mode 88 provides a user with a single device that a pair of half portions. The pair of half portions connect to each other to allow a single vaporizing experience. A user can mix and match a variety of different first vaporizers 11 and second vaporizers 12 to provide different flavors.

The first mouthpiece has a first mouthpiece taper 41 with a first mouthpiece taper back 43 that is flat. The second mouthpiece has a second mouthpiece taper 42 with a second mouthpiece taper back 44 that is flat. The first mouthpiece taper back 43 and the second mouthpiece taper back 44 connect with each other in a flat planar configuration to produce a single combined mouthpiece taper 45.

As seen in FIG. 3, the connected mode 88 vaporizer has a first charger port 21 and a second charger port 22 as each of the half portions contains its own battery. The first air intake port 23 is also separate from the air intake port of the other vaporizer.

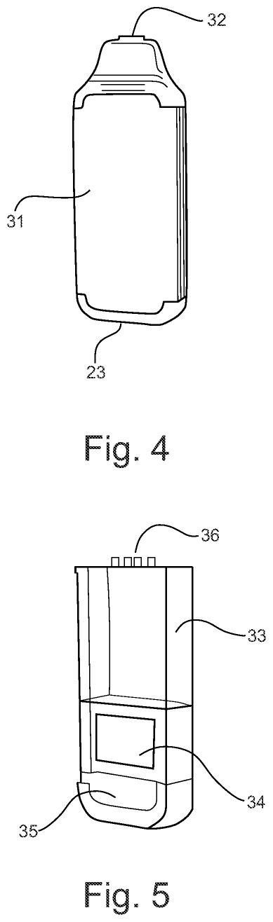

As seen in FIG. 4, the mouthpiece 32 connects to the outer housing 31. The mouthpiece 32 is opposite the first air intake port 23. The mouthpiece 32 is tapered and has a flat back. The outer housing 31 is rounded on the front and flat on the back.

As seen in FIG. 5, the vaporizer mouthpiece 32 can be removed and have only an oil tank 33 above the battery 34. An electronic controller 35 can be connected to electrical connectors 36 that detect when the mouthpiece 32 is removed. When the mouthpiece 32 is removed, the electrical connectors 36 can notify the electronic controller 35 to turn off the battery 34.

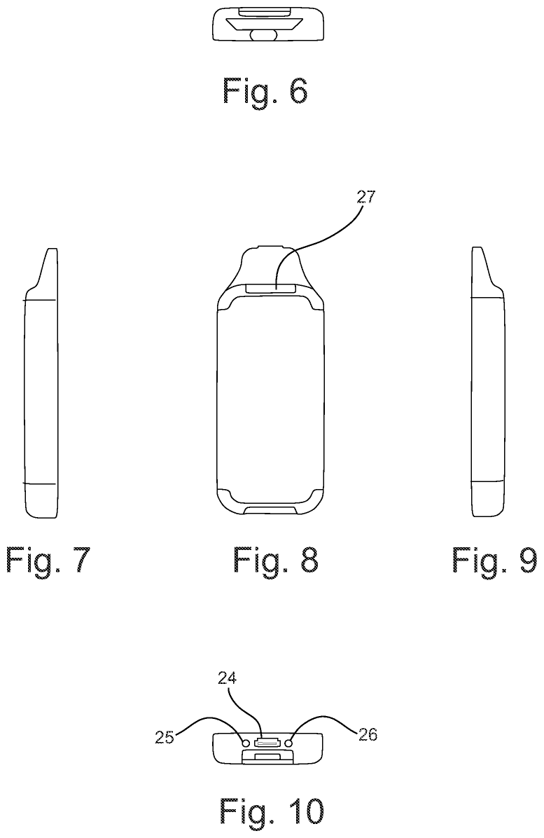

FIG. 6 is a top view of the present invention.

FIG. 7 shows a right view of the present invention.

FIG. 8 is a front view of the present invention.

FIG. 9 is a left view of the present invention.

FIG. 10 shows a bottom view of the present invention which shows a USB port 24. The USB port 24 can have a first USB magnet 25 and a second USB magnet 26. The USP magnets can facilitate quick connection of the USB port 24.

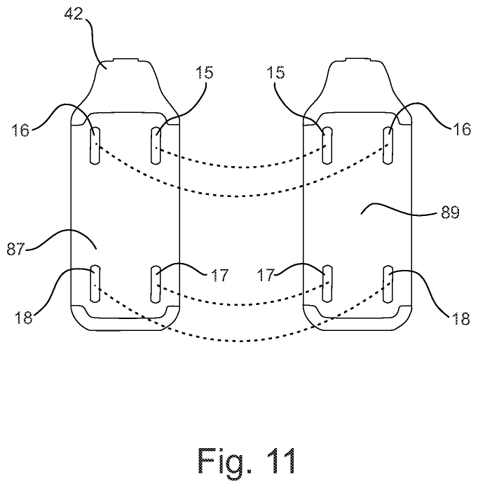

FIG. 11 is a back view of the present invention showing a first vaporizer back 89 and a second vaporizer back 87. The back field the present invention shows the elongated magnetic coupling connectors. The best mode is to have neodymium magnets on both the first and the second vaporizer so as to provide a solid connection. Alternatively, magnets can be placed on one side with ferrous metal on the other. It is preferred that the battery 34 rate of discharge be synchronized between the first and second vaporizer via the first and second vaporizer electronic controllers 35 when the attachment points make a connection between the first and second vaporizers.

Each of the first and second vaporizer pens comprise a power source and a cartridge. The power source and the cartridge are configured to be mechanically and electrically coupled to one another. For example, the cartridge may comprise an electrically conductive threaded fastener, and the power source may comprise an electrically conductive threaded receiver. The threaded fastener and the threaded receiver can be coupled to one another, thereby mechanically and electrically coupling the power source with the cartridge. The threaded fastener could also be a magnetically coupling fastener to allow quick parts swapping.

The vape pen, which may be manufactured from a metal, a polymer, a ceramic, or some other suitable material. As used herein, a “polymer” can refer to a formulation of manufactured materials comprising plastics, PVC, and/or some other compound that derives from the classification of a polymer or polymer derivative. A “ceramic” refers to a compound that is classified or derivative of such compound that are derived from clay or man-made materials that are listed in a suitable classification scheme as being ceramic, which may include compounds that are derived with some portion of the compound being ceramic in nature that is a blended or compounded material.

The housing is rectangular and elongated in nature. It is to be understood, however, that the housing may be any suitable shape. The housing comprises a first end and a second end that is opposite the first end, and also includes an interior. The back of the housing has magnetic construction allowing it to join another assembly conveniently.

The magnetic attachment being rectangular can allow attachment at different angles such as at 180° from each other to provide a fidget toy functionality.

1. A vaporizer apparatus comprising:
a. a first vaporizer, wherein the first vaporizer further includes a first mouthpiece, a first oil tank, a first battery and a first electronic controller;
b. a second vaporizer; wherein the second vaporizer further includes a second mouthpiece, a second oil tank, a second battery, and a second electronic controller;
c. a first vaporizer back, wherein the first vaporizer back is formed on the first vaporizer, wherein the first vaporizer back has a flat face;
d. a second vaporizer back, wherein the second vaporizer back is formed on the second vaporizer, wherein the second vaporizer back has a flat face;
e. a magnetic attachment connecting the first vaporizer to the second vaporizer, wherein the magnetic attachment biases the first mouthpiece to the second mouthpiece allowing user inhalation from both the first mouthpiece and the second mouthpiece simultaneously when the vaporizer apparatus is in the connected mode, wherein the first vaporizer and the second vaporizer are separated from each other in a separated mode.

2. The vaporizer apparatus of claim 1, wherein the magnetic attachment further includes: a first upper attachment, a second upper attachment, the first lower attachment, and a second lower attachment, which are formed on both the first vaporizer back and the second vaporizer back.

3. The vaporizer apparatus of claim 1, wherein the first mouthpiece and the second mouthpiece are adjacent in the connected mode.

4. The vaporizer apparatus of claim 1, wherein the magnetic attachment further includes an electrical connection between the first vaporizer and the second vaporizer, wherein the electrical connection connects the first electronic controller to the second electronic controller, wherein the first electronic controller and the second electronic controller synchronize vapor production.

5. The vaporizer apparatus of claim 1, wherein the first mouthpiece has a first mouthpiece taper, wherein the second mouthpiece has a second mouthpiece taper, wherein the first mouthpiece taper has a flat first mouthpiece taper back, wherein the second mouthpiece taper has a flat second mouthpiece taper back, wherein the first mouthpiece taper back conforms to second mouthpiece taper back to provide a combined mouthpiece taper.

6. The vaporizer apparatus of claim 5, wherein the magnetic attachment further includes: a first upper attachment, a second upper attachment, the first lower attachment, and a second lower attachment, which are formed on both the first vaporizer back and the second vaporizer back.

7. The vaporizer apparatus of claim 5, wherein the first mouthpiece and the second mouthpiece are adjacent in the connected mode.

8. The vaporizer apparatus of claim 5, wherein the magnetic attachment further includes an electrical connection between the first vaporizer and the second vaporizer, wherein the electrical connection connects the first electronic controller to the second electronic controller, wherein the first electronic controller and the second electronic controller synchronize vapor production.

9. The vaporizer apparatus of claim 8, wherein the magnetic attachment further includes: a first upper attachment, a second upper attachment, the first lower attachment, and a second lower attachment, which are formed on both the first vaporizer back and the second vaporizer back.

10. The vaporizer apparatus of claim 8, wherein the first mouthpiece and the second mouthpiece are adjacent in the connected mode.

11. The vaporizer apparatus of claim 10, wherein the magnetic attachment further includes: a first upper attachment, a second upper attachment, the first lower attachment, and a second lower attachment, which are formed on both the first vaporizer back and the second vaporizer back.
